(19) United States
(12) Patent Application Publication
(10) Pub. No.: US 2005/0164662 A1
(43) Pub. Date: Jul. 28, 2005

(54) Frequency conversion in a receiver

(76) Inventors: Chaowen Tseng, Taipei (TW); Wai Lau, Taipei (TW)

Correspondence Address: RABIN & Berdo, PC, 1101 14TH STREET, NW, SUITE 500, WASHINGTON, DC, 20005, US

(21) Appl. No.: 10/762,455

(22) Filed: Jan. 23, 2004

(51) Int. Cl. H04B 1/00

(52) U.S. Cl. 455/131

(57) ABSTRACT

A method for frequency conversion of a receiver, including the steps of receiving a signal having a radio frequency and carrying information on a plurality of channels, selecting one of the channels, converting the signal from the radio frequency to a first variable frequency determined by the selected channel, and converting the signal from the first frequency to a desired frequency.

### BACKGROUND OF THE INVENTION

1. Field of the Invention

The present invention relates to frequency conversion and particularly to a double or triple conversion of an RF signal in a TV tuner.

2. Description of the Prior Art

Broadband tuners are used in a variety of consumer and commercial systems such as TVs, VCRs and more sophisticated devices that include cable modems and cable set-top-boxes. There are more than 300 million broadband tuners produced every year.

More and more services are being offered through broadcast TV and cable operators, resulting in a rapidly evolving and convergent market. The vision of incorporating DVD, VCR, Personal Video Recording, and Internet functionality into a TV set or a set-top-box or even a personal computer is a key feature of the media center of tomorrow.

Serving as the RF front-end of broadband signals, the tuner is responsible for receiving all available channels, selecting the desired channel and filtering out the others. These tuners operating over a frequency ranging from 40 to 900 MHz have different performance requirements than traditional TV tuners. Smaller form factors, low power consumption, high reliability and ease of manufacture are the new concerns of the latest tuner applications.

In a TV tuner, frequency conversion architecture is essential to a tuner design.

In U.S. Pat. No. 5,737,035, Robert Rudolf Rotzoll et al. disclose a highly integrated double conversion television tuner on a single microcircuit, as shown in FIG. 1. The RF signal enters a TV tuner 100 from an antenna 402 (or cable, not shown) and is passed through a RF low-pass filter (RFLPF) 404 to limit the incoming band to below 900 MHz. The filtered RF signal is amplified up to 20 dB by a gain-controlled low-noise transconductance amplifier (LNTA) 406.

The output of a first local oscillator (LO1) 450, operating between 1200 and 2100 MHz, is mixed in a first mixer (MIX1) 408 with the RF signal to generate a first IF video carrier frequency of 1200 MHz. This approach leads to minimum distortion due to mixer images and harmonic mixing. The first IF is crudely filtered by the bandwidth limitation of the first mixer 408 to minimize harmonic effects.

The first IF signal of 1200 MHz is mixed in a second mixer (MIX2) 410, which is an image-rejection mixer, with the fixed 1180 MHz reference output of a second local oscillator (LO2) 412 to generate the second IF at 20 MHz visual carrier. Because the RF input signal is lower in frequency than the LO referenced, the mixing of the two signals will result in a down conversion of the RF input.

In the previously described TV tuner, however, the out-of-band channels must be removed by an external RF SAW (surface acoustic wave) filter, which necessitates a highly linear SAW driver requiring a large power consumption in the tuner chip. Further, the PLL (phase lock loop) circuit to generate the oscillation signal for the first mixer operates at a high frequency, which results in a spurious output of the first mixer.

### SUMMARY OF THE INVENTION

The object of the present invention is to provide a TV tuner with fewer elements, a lower power consumption and high signal-to-noise ratio.

The present invention provides a method for frequency conversion of a receiver, including the steps of receiving a signal having a radio frequency and carrying information in a plurality of channels, selecting one of the channels, converting the signal from the radio frequency to a first variable frequency determined by the selected channel, and converting the signal from the first frequency to a second frequency.

The present invention provides a receiver including an antenna receiving an RF signal carrying information in a plurality of channels, a first local oscillator generating a first oscillating signal having a first variable frequency determined by a selected one of the channels, a first mixer mixing the RF signal with the first oscillating signal to generate an intermediate signal, a second local oscillator generating a second oscillating signal having a second frequency, and a second mixer mixing the intermediate signal with the second oscillating signal to generate a baseband signal, wherein a frequency of the intermediate signal is variable and determined by the selected channel.

The present invention provides another receiver including an antenna receiving an RF signal carrying information on a plurality of channels, a first local oscillator generating a first oscillating signal having a first variable frequency determined by a selected one of the channels, a first mixer mixing the RF signal with the first oscillating signal to generate a first intermediate signal, a second local oscillator generating a second oscillating signal having a second frequency, a second mixer mixing the first intermediate signal with the second oscillating signal to generate a second intermediate signal, a third local oscillator generating a third oscillating signal having a third frequency, and a third mixer mixing the second intermediate signal with the third oscillating signal to generate a baseband signal, wherein a frequency of the first intermediate signal is variable and determined by the selected channel.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a diagram showing a conventional TV tuner.

FIG. 2 is a diagram showing a TV tuner according to one embodiment of the invention.

FIG. 3 is a diagram showing an oscillator in a TV tuner according to one embodiment of the invention.

FIG. 4 is a diagram showing a TV tuner according to another embodiment of the invention.

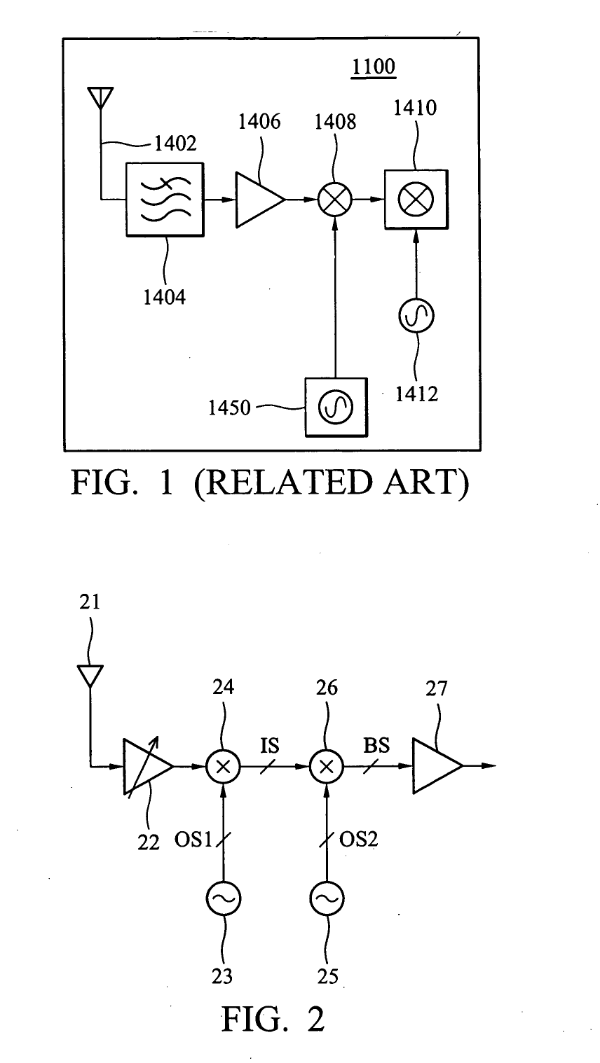

### DETAILED DESCRIPTION OF THE INVENTION

FIG. 2 is a diagram showing a TV tuner according to one embodiment of the invention. The TV tuner (receiver) includes an antenna 21 receiving an RF signal carrying information in all TV channels, a low noise amplifier 22 coupled to the antenna 21 to amplify the RF signal, a first local oscillator 23 generating a first oscillating signal OS1 having a first frequency FO1, a first mixer 24 mixing the amplified RF signal with the first oscillating signal OS1 to generate an intermediate signal IS, a second local oscillator 25 generating a second oscillating signal OS2 having a second frequency FO2, a second mixer 26 mixing the intermediate signal IS with the second oscillating signal OS2 to generate a baseband signal BS, and a SAW driver 27 coupled to an output of the second mixer 26 to drive an external SAW filter (not shown).

The first local oscillator 23 and mixer 24 form a first frequency conversion stage converting the RF signal from the radio frequency to a variable intermediate frequency IF determined by the selected TV channel. The frequency IF is higher than the radio frequency (up-conversion) and is determined to minimize noise and spurious signals coupled from the other channels into the selected channel. The value of the frequency IF is different for each channel. The second local oscillator 25 and mixer 26 form a second frequency conversion stage converting the signal from the frequency IF to a baseband frequency BF (down-conversion) which is fixed for all channels. The mixers 24 and 26 are image rejection mixers rejecting in-band noise from the image frequency. The out-of-band signals are rejected by the LC tanks (not shown) inside the mixers 24 and 26.

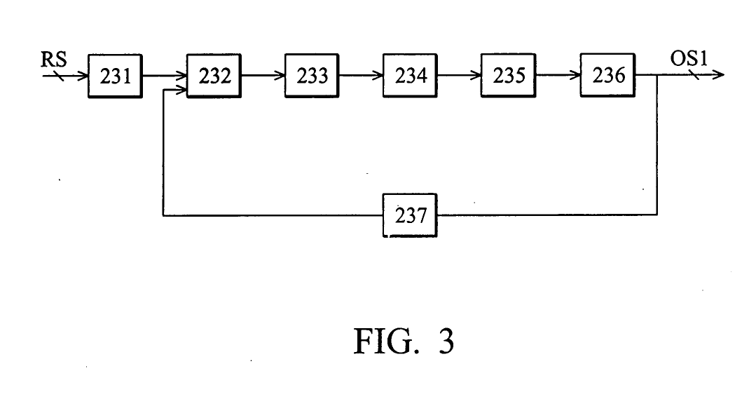

FIG. 3 is a diagram showing the oscillator 23. The oscillator includes a first frequency divider 231 dividing a frequency FR of a reference signal RS by a divisor N, a phase frequency detector 232 having a first input coupled to an output of the first frequency divider 231, a charge pump 233 having an input coupled to an output of the phase frequency detector 232, a loop filter 234 having an input coupled to an output of the charge pump 233, a voltage controlled oscillator 235 having an input coupled to an output of the loop filter 234, a second frequency divider 236 dividing a frequency of the signal output from the voltage controlled oscillator 235 by a divisor P and outputting the first oscillating signal OS1, and a frequency multiplier 237 multiplying the first oscillating signal OS1 by a multiplicator M and having an output coupled to a second input of the phase frequency detector 232. The divisors N and P, and the multiplicator M are determined by the selected channel. The frequency FO1 of the first oscillating signal OS1 are derived by the following equation.
FO1=FR*M/(P*N)

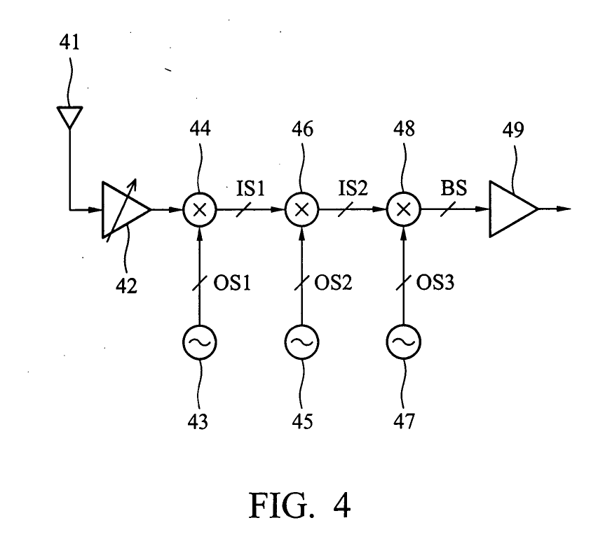

FIG. 4 is a diagram showing a TV tuner according to another embodiment of the invention. The TV tuner applies triple conversion rather than double conversion (shown in FIG. 2) to the RF signal. The TV tuner includes an antenna 41 receiving an RF signal carrying information from all TV channels, a low noise amplifier 42 coupled to the antenna 41 to amplify the RF signal, a first local oscillator 43 generating a first oscillating signal OS1 having a first frequency FO1, a first mixer 44 mixing the amplified RF signal with the first oscillating signal OS1 to generate a first intermediate signal IS1, a second local oscillator 45 generating a second oscillating signal OS2 having a second frequency FO2, a second mixer 46 mixing the first intermediate signal IS1 with the second oscillating signal OS2 to generate a second intermediate signal IS2, a third local oscillator 47 generating a third oscillating signal OS3 having a third frequency FO3, a third mixer 48 mixing the second intermediate signal IS2 with the third oscillating signal OS3 to generate a baseband signal BS, and a SAW driver 49 coupled to an output of the third mixer 48 to drive an external SAW filter (not shown).

The first local oscillator 43 and mixer 44 form a first frequency conversion stage converting the RF signal from the radio frequency to a variable intermediate frequency IF1 determined by the selected TV channel. The frequency IF1 is higher than the radio frequency (up-conversion) and is determined to minimize noise and spurious signals coupled from the other channels into the selected channel. The value of the frequency IF1 is different for each channel. The second local oscillator 45 and mixer 46 form a second frequency conversion stage converting the signal from the frequency IF1 to a second intermediate frequency IF2 (down-conversion) which is fixed for all the channel. The third local oscillator 47 and mixer 48 form a third frequency conversion stage converting the signal from the frequency IF2 to a baseband frequency (down-conversion). The mixers 44, 46 and 48 are image rejection mixers rejecting in-band noise from the image frequency. The out-of-band signals are rejected by the LC tanks (not shown) inside the mixers 44, 46 and 48.

Each of the oscillators 43 and 45 is the same as that shown in FIG. 3. When a channel is selected by the user, the divisors N and P, and the multiplicator M of each oscillator 43 and 45 are simultaneously determined.

It should be noted that the triple conversion tuner shown in FIG. 4 achieves wide-to-narrow band conversion and down-conversion with two mixers 46 and 48, while the double conversion tuner shown in FIG. 2 accomplishes the same with one single mixer 26.

In conclusion, the present invention provides a TV tuner with fewer elements, a lower power consumption and high signal-to-noise ratio. Especially, by comparing to the TV tuner disclosed in U.S. Pat. No. 5,737,035, the TV tuner of the present invention has an advantage that no RF SAW filter is necessary to pre-process the signal sent to the TV tuner, which eliminates the need for a highly linear SAW driver and thus reduces the power consumption.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

1. A method for frequency conversion in a receiver, comprising the steps of:
receiving a signal having a radio frequency and carrying information on a plurality of channels;
selecting one of the channels;
converting the signal from the radio frequency to a first variable frequency determined by the selected channel; and
converting the signal from the first frequency to a second frequency.

2. The method as claimed in claim 1, wherein the first frequency is determined so that noise coupled from the other channels into the selected channel is minimized.

3. The method as claimed in claim 1, wherein the first frequency is higher than the radio frequency.

4. The method as claimed in claim 1, wherein the second frequency is fixed for all the channels.

5. The method as claimed in claim 1, wherein the second frequency is a baseband frequency.

6. The method as claimed in claim 1 further comprising the step of:
converting the signal from the second frequency to a third frequency.

7. The method as claimed in claim 6, wherein the first frequency is determined to minimize noise coupled from the other channels into the selected channel.

8. The method as claimed in claim 6, wherein the first frequency is higher than the radio frequency.

9. The method as claimed in claim 6, wherein the second frequency is fixed for all the channels.

10. The method as claimed in claim 6, wherein the second frequency is lower than the first frequency.

11. The method as claimed in claim 6, wherein the third frequency is fixed for all the channels.

12. The method as claimed in claim 6, wherein the third frequency is a baseband frequency.

13. A receiver comprising:
an antenna receiving an RF signal carrying information on a plurality of channels;
a first local oscillator generating a first oscillating signal having a first frequency;
a first mixer mixing the RF signal with the first oscillating signal to generate an intermediate signal;
a second local oscillator generating a second oscillating signal having a second frequency; and
a second mixer mixing the intermediate signal with the second oscillating signal to generate a baseband signal;
wherein a frequency of the intermediate signal is variable and determined by the selected channel.

14. The receiver as claimed in claim 13, wherein the frequency of the intermediate signal is determined so that noise coupled from the other channels into the selected channel is minimized.

15. The receiver as claimed in claim 13, wherein the first oscillator comprises:
a first frequency divider dividing a frequency FR of a reference signal by a divisor N;
a phase frequency detector having a first input coupled to an output of the first frequency divider;
a charge pump having an input coupled to an output of the phase frequency detector;
a loop filter having an input coupled to an output of the charge pump;
a voltage controlled oscillator having an input coupled to an output of the loop filter;
a second frequency divider dividing a frequency of a signal output from the voltage controlled oscillator by a divisor P and outputting the first oscillating signal; and
a frequency multiplier multiplying the first oscillating signal by a multiplicator M and having an output coupled to a second input of the phase frequency detector.

16. The receiver as claimed in claim 15, wherein the divisors N and P, and the multiplicator M are determined by the selected channel.

17. The receiver as claimed in claim 13 further comprising a low noise amplifier coupled between the antenna and the first mixer to amplify the RF signal.

18. The receiver as claimed in claim 13 further comprises a SAW driver coupled to an output of the second mixer.

19. The receiver as claimed in claim 13, wherein the first and second mixers are image rejection mixers.

20. A receiver comprising:
an antenna receiving an RF signal carrying information in a plurality of channels;
a first local oscillator generating a first oscillating signal having a first frequency;
a first mixer mixing the RF signal with the first oscillating signal to generate a first intermediate signal;
a second local oscillator generating a second oscillating signal having a second frequency;
a second mixer mixing the first intermediate signal with the second oscillating signal to generate a second intermediate signal;
a third local oscillator generating a third oscillating signal having a third frequency; and
a third mixer mixing the second intermediate signal with the third oscillating signal to generate a baseband signal;
wherein a frequency of the first intermediate signal is variable and determined by the selected channel.

21. The receiver as claimed in claim 20, wherein the frequency of the first intermediate signal is determined so that noise coupled from the other channels into the selected channel is minimized.

22. The receiver as claimed in claim 20, wherein each of the first and second oscillator comprises:
a first frequency divider dividing a frequency FR of a reference signal by a divisor N;
a phase frequency detector having a first input coupled to an output of the first frequency divider;
a charge pump having an input coupled to an output of the phase frequency detector;
a loop filter having an input coupled to an output of the charge pump;
a voltage controlled oscillator having an input coupled to an output of the loop filter;
a second frequency divider dividing a frequency of a signal output from the voltage controlled oscillator by a divisor P and outputting the first oscillating signal; and
a frequency multiplier multiplying the first oscillating signal by a multiplicator M and having an output coupled to a second input of the phase frequency detector.

23. The receiver as claimed in claim 22, wherein the divisors N and P, and the multiplicator M are determined by the selected channel.

24. The receiver as claimed in claim 20 further comprising a low noise amplifier coupled between the antenna and the first mixer to amplify the RF signal.

25. The receiver as claimed in claim 20 further comprises a SAW driver coupled to an output of the third mixer.

26. The receiver as claimed in claim 20, wherein the first, second and third mixers are image rejection mixers.
